(19) United States
(12) Patent Application Publication
(10) Pub. No.: US 2010/0043066 A1
(43) Pub. Date: Feb. 18, 2010

(54) MULTIPLE SECURITY LAYERS FOR TIME-BASED NETWORK ADMISSION CONTROL

(76) Inventor: Gary S. Miliefsky, Tyngsboro, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/469,173

(22) Filed: May 20, 2009

Related U.S. Application Data
(60) Provisional application No. 61/054,979, filed on May 21, 2008.
(60) Provisional application No. 61/139,878, filed on Dec. 22, 2008.

(51) Int. Cl. H04L 9/32

(52) U.S. Cl. 726/9; 726/15

(57) ABSTRACT

Embodiments of the present invention include a computer method of controlling access to a computer-based network comprising: (i) receiving an indication of an attempt to gain access to a computer-based network; (ii) applying a respective network access control policy to determine whether to allow the attempt to gain access to the computer-based network at each of multiple security layers; and (iii) allowing or blocking the attempt to gain access through the security layer to the computer-based network based on the application of the respective network access control policy at each security layer. Other embodiments include a computer method of controlling access to a computer-based network comprising: (a) scanning a host computer for viruses; (b) temporarily disabling a firewall of the host computer during an audit; and (c) shutting down high risk services running on the host computer.

### RELATED APPLICATIONS

This application claims the benefit of U.S. Provisional Application No. 61/054,979, filed on May 21, 2008, and of U.S. Provisional Application No. 61/139,878, filed on Dec. 22, 2008. The entire teachings of the above applications are incorporated herein by reference.

### BACKGROUND OF THE INVENTION

Network access control or network admission control (collectively, NAC) is an approach to computer network security that attempts to unify endpoint security technology (such as antivirus, host intrusion prevention, and vulnerability assessment), user or system authentication and network security enforcement. Unfortunately, conventional NAC systems cannot always detect and manage access for trusted assets that are healthy. In addition, conventional NAC solutions cannot always detect and manage access for trusted assets that are unhealthy due to common vulnerabilities and exposures (CVEs), poor security configurations, policy and compliance issues, infections by malware, such as trojans, keyloggers, viruses, worms, spyware, adware, and other blended threats.

Another problem with conventional NAC systems is the inability to detect un-trusted, malicious, or rogue assets such as a PDA, laptop, desktop, server, wireless device or access point brought into an internal network by a hacker, cyber criminal or cyber terrorist or by a malicious trusted insider. While conventional NAC systems may be suitable for the particular purpose that they address, they are not as suitable for the improvement of network security on public and private networks. This is because they cannot alert, block and correct network problems related to the introduction, re-introduction, or removal of network assets.

### SUMMARY OF THE INVENTION

The present invention relates generally to network and information security (INFOSEC) solution for multi-layered, time-based network admission control or network access control (collectively, NAC). More specifically, it relates to NAC systems and methods comprising multiple security layers for time-based NAC for the improvement of network security on public and private networks. Embodiments of the present invention can alert and block network problems related to the introduction, re-introduction, and removal of network assets from the network.

NAC and user authentication solutions as well as traditional access control lists (ACLs) have been in use for years. Typically, these access control solutions are designed to deal with users coming and going on a corporate, private, or public network which may comprise firewalls, virtual private networks (VPNs), intrusion detection systems (IDS), intrusion prevention systems (IPSs), antivirus solutions, hubs, switches, smart switches that create virtual LAN (VLANs), endpoint defense software, host-based intrusion prevention systems (HIPS), vulnerability management systems, routers, gateways and other networking equipment to help foster secure connections on computer-based networks.

Embodiments of the present invention include a security apparatus comprising an alerting system that determines the current state of the computer-based network, a blocking system that communicates with the alerting system, and a time engine that provides time information to either the alerting system, the blocking system, or both. The current state of the network may include information about the introduction, re-introduction, removal, or off-line condition of a network asset. The blocking system may prevent network assets from gaining access to the network based on the current state of the network.

Example inventive alerting systems determine the current state of the computer-based network by checking network assets at multiple layers. For example, inventive alerting systems may conduct health checks, such as checks for common vulnerabilities and exposures (CVEs), anti-virus status, anti-malware status, and installed patches installed. They may also check identity and policy enforcement agents; universal serial bus (USB) tokens; fingerprint scanners; as well as core signatures including but not limited to operating systems; network ports; applications; services; memory; internet protocol (IP) addresses; media access controller (MAC) addresses; open or closed data ports such as infrared (IR); wireless; keyboard; mouse; USB and Bluetooth; and time. Inventive alerting systems may also apply NAC policies to network assets, check the health of network assets, and maintain trusted user lists and access control systems. They may also check assets against time schedules based on information from the time engine and trusted asset/user lists.

Example inventive blocking systems may use time schedules for network assets to determine when to block a network asset from the computer-based network. When blocking an asset, the inventive blocking systems may prevent network assets from gaining access to the computer-based network at any one of plural layers. Layers may include, but are not limited to: denial-of-service streams; smart switches; Ethernet ports; network ports; and firewalls. Inventive blocking systems may dynamically reconfigure access to the computer-based network to block malware, hackers, rogue devices, and malicious insiders by terminating all or part of a network asset's access to the network.

Embodiments of the blocking system may include, but are not limited to: a network manager blocking engine that blocks access to network assets based on NAC policies; a host manager blocking engine that blocks access to local assets by communicating securely with agent or client software based on NAC policies; a countermeasures communications engine that dynamically reconfigures countermeasures to enforce network access control policies; and a policy and compliance subsystem that maintains tables for changing group policy information of the NAC policies.

Example inventive time engines may be used to create, enable, and track NAC schedules. For instance, the schedules may be set so that the inventive security apparatus only grants access to network assets based on specified time intervals, the current time, device identification, and/or user identification.

Further embodiments of the present inventive security apparatus may include a correction system operably coupled to the alerting system, the blocking system, and/or the time engine. Inventive correction systems provide correction of network problems; they may also record time stamps associated with when network problems are discovered and when network problems are corrected. They may include any of: a network manager correction engine that corrects information related to network assets based on network access control policies; a host manager correction engine that corrects local issues by communicating securely with agent or client software based on network access control policies; a correction communications engine that dynamically resolves network problems to create a healthier network environment and to enforce network access control policies; and a vulnerabilities subsystem that maintains information relating to vulnerabilities of network assets.

Still other embodiments of the present inventive security apparatus may include an interface that enables a user to apply policy templates and policies relating to NAC decisions, including decisions related to alerting determinations and blocking access to selected network assets. Example policy templates include compliance templates, pre-defined templates, and user-defined templates. Inventive interfaces can also enable a user to set thresholds and measures around a state of health of a network asset.

Yet further embodiments of the present inventive security apparatus may include a network sniffer that scans connection interfaces of network assets to the computer-based network. They may also include energy conservation interfaces that shut down network assets to reduce emissions. Alternatively, the energy conservation interfaces may place network assets in hibernate mode, sleep mode, or standby mode to reduce emissions.

Embodiments of the present invention also include computer methods of controlling access to a computer-based network. Inventive methods include receiving indications of network access attempts; applying respective NAC policies at each of multiple security layers to determine whether to allow or block the network access attempts; and allowing or blocking the attempt to gain access through the security layer based on the application of the respective NAC policy at each security layer. NAC policies include, but are not limited to: determining whether the attempt to gain access is occurring during an allowed access time; determining whether the attempt to gain access is occurring from an allowed physical location or on an allowed network asset; authenticating a token associated with a particular user or a particular network asset; and determining whether the attempt to gain access is directed towards a selected network asset.

Embodiments of the inventive computer methods may further include recording and logging when the attempt to gain access to the computer-based network occurs.

Still further embodiments include of the present invention include a computer method of providing access control to a computer-based network by: (a) receiving an indication of an attempt to gain access to a computer-based network; (b) applying a NAC policy at each of multiple security layers to determine whether to allow the attempt to gain access to the computer-based network; and, (c) based on the application of the NAC policy at each security layer, allowing or blocking the attempt to gain access through the security layer to the computer-based network.

Security layers may include: (i) a network traffic layer that detects which devices are on the network; (ii) a communications protocol layer that conducts remote inspections of devices on the network; (iii) an application layer that conducts local inspections of devices on the network using agents; (iv) a multi-factored token layer that authenticates tokens associated with users or devices; (v) a location layer that verifies whether access attempts originate from allowed locations; and (vi) a time layer that verifies whether access attempts occur during allowed times.

Further embodiments include determining whether the attempt to gain access is occurring during an allowed access time or originating from an allowed physical location or on an allowed network asset. Embodiments may also apply the network access control policy by authenticating a token associated with a particular user or a particular network asset.

Other embodiments may record a date and time (or similar indication) of the attempt to gain access to the computer-based network. Embodiments may also determine whether the attempt to gain access is directed towards a selected network asset. In addition, embodiments may log the attempt to gain access to the computer-based network.

Still other embodiments are computer methods of providing access control to a computer-based network including: (a) scanning a host computer for viruses; (b) temporarily disabling a firewall of the host computer during an audit; and (c) shutting down high risk services running on the host computer. Embodiments of the method include disabling ports (e.g., USB ports) and interfaces of host computers. Yet other embodiments may include forcing enablement of patch management and OVAL integration. Further embodiments may include reducing energy consumption by putting the host computer into a standby state.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram of a general computer environment and network architecture.

FIG. 2 is a block diagram of the internal structure of a computer in the network architecture of FIG. 1.

FIG. 3 is a schematic diagram of a computer network architecture with NAC hardware and software implementing the present invention.

FIG. 4 is schematic diagram illustrating assessment, assignment, and enforcement of a NAC policy.

FIG. 5 is a schematic view of the architecture of one embodiment.

FIG. 6 is a diagram of an architectural overview of an alerting system.

FIG. 7 is a diagram of an architectural overview of a blocking system.

FIG. 8 is a diagram of an architectural overview of a correcting system.

### DETAILED DESCRIPTION OF THE INVENTION

A description of example embodiments of the invention follows.

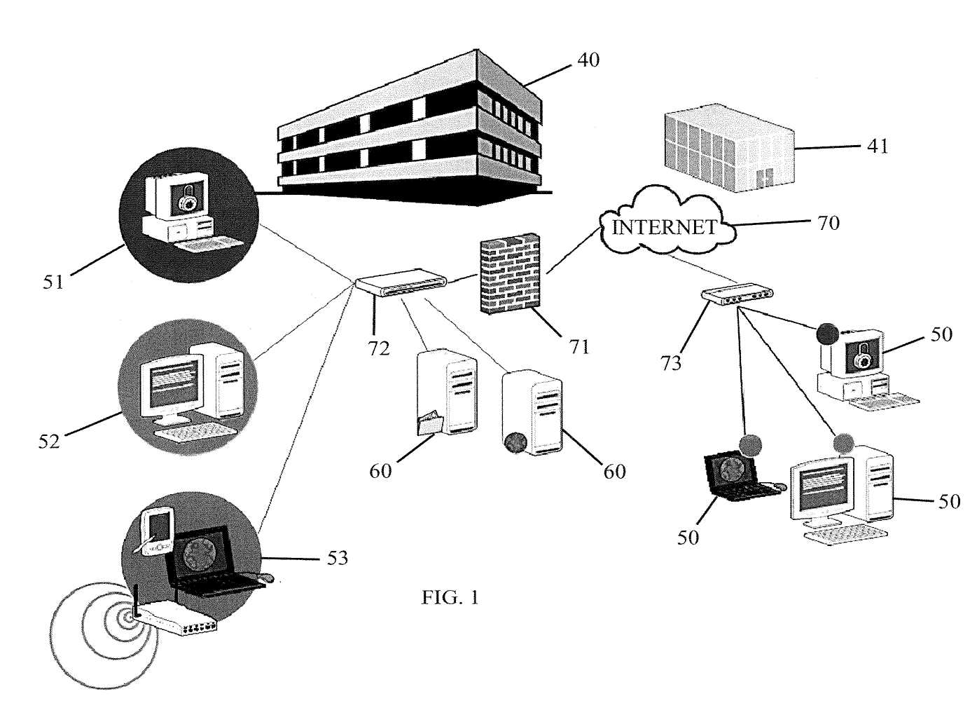

FIG. 1 illustrates a computer network or similar digital processing environment in which the present invention may be implemented. Host computers/devices 50 and server computers 60 provide processing, storage, and input/output devices executing application programs and the like. Host computers/devices 50 can also be linked through communications network 70 to other computing devices, including other host devices/processes 50 and server computers 60. Communications network 70 can be part of a remote access network, a global network (e.g., the Internet), a worldwide collection of computers, local area or wide area networks (LANs or WANs), and gateways that currently use respective protocols (TCP/IP, Bluetooth, etc.) to communicate with one another. Other electronic device/computer network configurations and architectures are suitable.

Communications network 70 can be linked to individual host computers/devices 50 through switches 72 and routers 73, which may be situated behind firewalls 71 that protect the network 70 from viruses, malware, etc. Switches 72 and routers 73 may be located at corporate headquarters 40 and branch offices 41 to allow users to communicate with each other on a private network, such as a corporate, university, education, or government internal network. The private networks may be virtual private networks (VPNs). For example, firewalls 71 may be used to block connections between the network 70 and trusted, weak, infected (noncompliant with policy) hosts 52 or untrusted, malicious, rogue hosts 53. At the same time, firewalls 71 should allow trusted, healthy (i.e., in compliance with policies) hosts 51 to access the network 70. Unfortunately, there are many threats, vulnerabilities, and exposures that firewalls 71 alone cannot remedy or defend against.

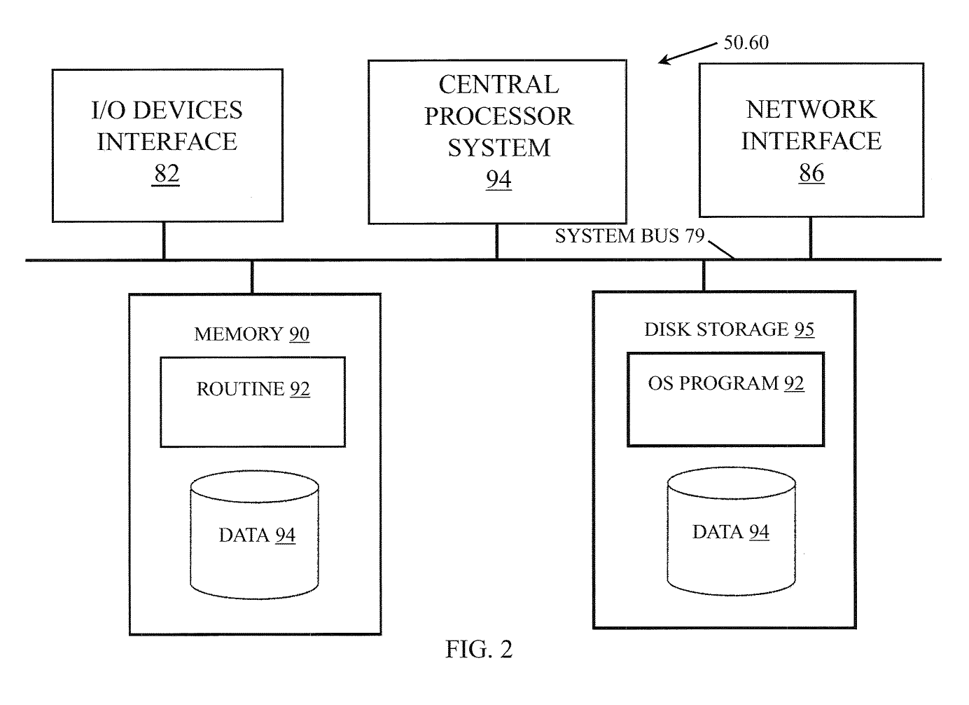

FIG. 2 is a diagram of the internal structure of a computer (e.g., hosts 50-53 or server computers 60) in the computer network of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., security layers, policy engines, security agents, and enforcement members as described below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer.

In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like.

### Network Access Control (NAC) Systems

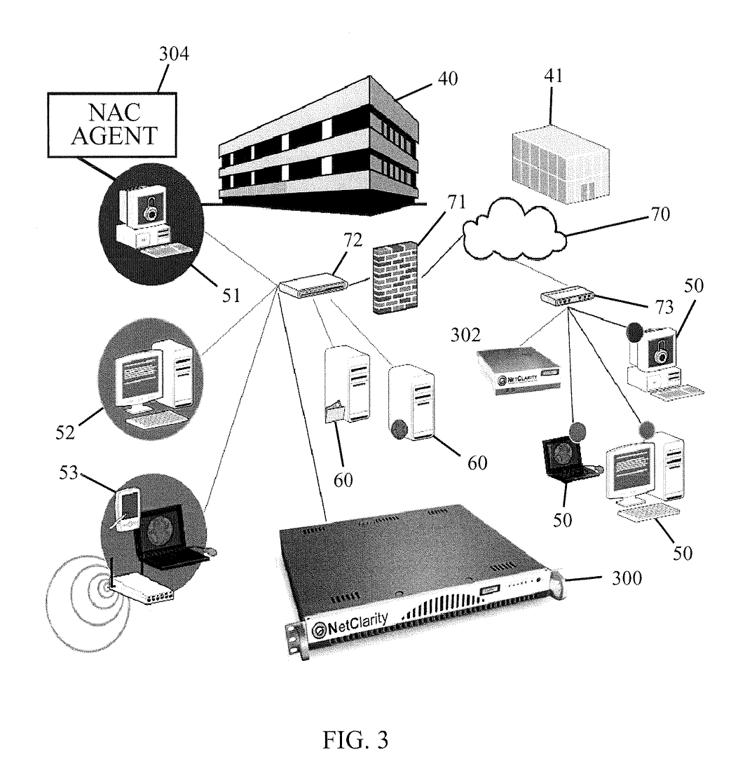

FIG. 3 is a diagram of a network environment with NAC hardware and optional NAC software of the present inventive system. The NAC hardware includes a NAC enterprise appliance 300, which may be located at a corporate headquarters 40, and a NAC branch unit 302, which may be located at a branch office 41 for example. Optional NAC software, such as optional NAC agent 304, may also be installed on hosts 50-53 to assess the health and trusted status of the hosts 50-53.

NAC systems can be integrated into computer networks in a variety of ways. As shown in FIG. 3, for example, neither the NAC enterprise appliance 300 nor the NAC branch unit 302 is situated in the path that links the hosts 50 to the network 70, switch 72, or router 73. In preferred embodiments of the present inventive system, the NAC enterprise appliance 300 is a NetClarity® Enterprise NACwall and the NAC branch unit 302 is NetClarity® Branch NACwall or NetClarity® Micro NACwall that generate only small amounts of heat and consume little power because they use low-power processors, such as the AMCC Power Architecture processors.

The architecture shown in FIG. 3 is known as an out-of-band architecture because the appliance 300 and branch unit 302 are not located directly in the data path. Because the appliance 300 and branch unit 302 are not in the data path, their failures will not affect data flow within the network. Out-of-band NAC systems use methods including 802.1X, Dynamic Host Configuration Protocol (DHCP), and address resolution protocol (ARP) management, or virtual LAN (VLAN) steering to enforce policy. As hosts or assets come online, the out-of-band NAC system intervenes and performs pertinent assessment(s), then grants access where appropriate.

In-line NAC architectures use appliances situated between the access switch and the distribution switch. An in-line NAC product can block traffic, like a network firewall, but its ACL is tailored to individual hosts. Switch-based NAC systems are similar to in-line NAC systems, but enforcement occurs on the switch 72 or router 73 itself. Host-based NAC systems rely on installed host agents (e.g., optional NAC agent 304) to assess and enforce access policy. Installed agents are centrally managed, and the access policy follows the host even when it is off-network. Unlike network-based enforcement mechanisms, host-based NAC agents can control which applications can use the network in addition to the traffic passing to and from the network.

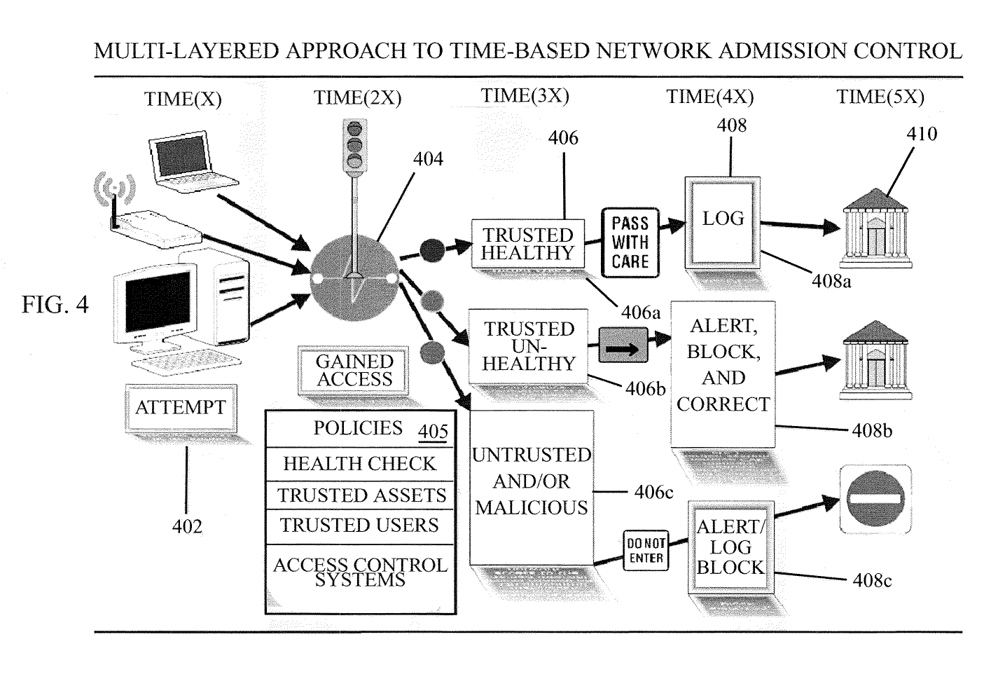

FIG. 4 is a diagram that illustrates how a host 402 gains access to or is blocked from accessing a network asset 410. Attempts to connect to a computer network protected by a NAC system typically include three phases: assessment, policy selection, and policy enforcement. Here, the host 402 attempts to gain access through an access point 404 that assesses the health and trusted status of the host 402. Assessment includes pre-admission assessment, which occurs before a host 402 is granted full access to the network, and post-admission assessment, which occurs after access has been granted. Pre-admission assessment enables the host 402 to be denied admission to the network if it poses a threat. Post-admission assessment enables the host 402 to be periodically reassessed to ensure it does not begin to pose a threat.

The access point 404 may perform the assessment by remotely scanning the host 402 or it may use information collected during a local health check by an agent (e.g., optional NAC agent 304) installed on the host 402. Assessments can use either permanently installed agents or dissolvable agents, so named because they disappear after they are used. Information gathered during an assessment may relate to a host's 402 operating system, patch levels, applications running or installed, security posture, system configuration, user login, and more. The access point 404 forwards the completed assessment to a NAC appliance, such as appliance 300 or branch unit 302 (FIG. 3).

In situations where it is impractical to grant administrator rights to agents, remote scanning methods can be used to query a host 402. For example, agentless assessments include vulnerability scans, remote procedure calls, and Windows management instrumentation. Alternatively, passive scanning, using intrusion detection and network anomaly detection, looks for malicious hosts based on actual traffic.

Based on the access point's 404 posture and policy 405 to be enforced, the NAC appliance (e.g., appliance 300 or branch unit 302 in FIG. 3) determines what access should be granted, possibly by using back-end systems, including antivirus, patch management or user directories, to help determine the host's condition. To make this determination, the NAC appliance (at appliance 300 or branch unit 302 in FIG. 3) may check the assessment against trusted asset lists, trusted user lists (e.g., user identifications, passwords, and tokens), and access control systems (e.g., proxy servers, firewalls 71, intrusion detection systems (IDSs), intrusion prevention systems (IPSs), VPNs, antivirus protection, and smart-switch rules). Tokens and passwords may include private or randomly generated passwords, biometric information, such as scanned fingerprints, and physical devices, such as USB keys. In some embodiments, security information includes dual-key encryption provided in part by security tokens that generate random numbers at fixed intervals (e.g., the RSA SecurID®).

Once the NAC appliance (e.g., appliance 300 or branch unit 302 in FIG. 3) determines which policy 405 to apply, the access point 404 either admits or blocks the attempt based on outcomes 406a, 406b, or 406c (generally, 406) of the policy determination. Policies may be rules-based or other implementation techniques may be employed. Outcomes 406 include verifying that: 406a the host 402 is trusted and healthy; 406b the host 402 is trusted but unhealthy and completely or partially out of compliance with the applied policy; or 406c the host 402 is untrusted and/or malicious.

Next, the NAC appliance (e.g., appliance 300 or branch unit 302 in FIG. 3) in conjunction with the access point 404 uses the outcome 406 for enforcement 408 (i.e., 408a, 408b, 408c) of the network policy. Trusted and healthy hosts of 406a are admitted to the network at 408b; trusted but unhealthy hosts of 406b are brought into compliance before being admitted to the network at 408b; and untrusted and/or malicious hosts of 408c are blocked from the network at 408c.

Enforcement 408 is the NAC system's response to a host state as defined by the policy created using the policy engine. Responses can range from doing nothing, to logging an event, to blocking or ejecting a computer from the network. Typical access-control enforcements use 802.1X, DHCP and ARP management, domain name system (DNS) redirection to a walled garden, system updating, and rate shaping to alter traffic or a user's network access.

Post-admission assessments can be initiated automatically after a set time period; by an administrator as needed; or based on a change in the host, such as a desktop firewall or AV being disabled. New assessments are compared with the current policy, and defined actions are taken. NAC systems that use passive network monitoring can issue alerts based on malicious activity, including changes in network traffic.

### Multi-Layer, Time-Based NAC Systems

NAC systems according to the present inventive system use multiple layers, including a time-based layer, to detect and defend against attacks by malicious and rogue users. In contrast, conventional NAC systems do not account for the time-based nature of work on a per end-user basis. Because conventional NAC systems do not account for when (date/time) access requests are made, conventional NAC systems may allow access requests from normally trusted users trying to access the network when the users should not be allowed to access the network.

Typically, end-users of computer equipment on private, corporate, education, or government networks have daily work schedules. In addition, there are rules as to when and where (specific location) each worker is allowed to be on the network. For example, in banking, tellers usually work from 8 am until 4 pm. If they were to have authenticated access to their computers at 9 pm, they should not be able to access internal network resources. Similarly, if ‘cleaning company’ personnel initiate computer activity in a front lobby, they should not be able to access internal network resources either.

In this instance, a conventional NAC system would see a fixed, trusted asset—the teller computer—accessing network resources and would allow this access to occur. In the present invention, a multi-layer, time-based NAC system includes a time and/or location schedule that alerts and blocks against internal computer and/or internal network usage at off hours and/or at protected locations. The teller, a trusted insider with proper credentials, would not have access when and/or where she should not have access. The inventive multi-layer, time-based NAC system also blocks attempts by the cleaning company personnel, who are trusted insiders without proper credentials, who access a computer that was left on and connected to the network.

By adding multiple layers to the network admission process, the present inventive NAC solution is stronger and, therefore, harder to defeat or circumvent. Embodiments of the present invention include: a network traffic layer that detects which devices are on the network; a communications protocol layer that conducts remote inspections of devices on the network; an application layer that conducts local inspections of devices on the network using agents; a multi-factored token layer that authenticates tokens associated with users or devices; a location layer that verifies whether access attempts originate from allowed locations; and a time layer that verifies whether access attempts occur during allowed times.

In preferred embodiments, the inventive NAC solution uses a server, such as a NetClarity NACwall appliance, that communicates with a client, such as NetClarity Endpoint Defender software. Rules can be added to the server to set single user or group policies that are pushed down to or pulled into each client system. For example, rules may govern one or more of the following: removable device usage (e.g., deny USB access, allow CD-ROM access, etc.); access by trusted services and applications to selected ports (e.g., allow Internet Explorer® to access ports 80 and 443); access by untrusted services and applications to ports (e.g., deny Napster access to all ports); patch server rules, schedules, and locations (e.g., get the latest updates from www.windowsupdate.com everyday at noon); firewall status (e.g., shut down the firewall during remote audits); antivirus scan schedules; schedules of when trusted assets go into sleep or standby mode to save power and/or deny access. Further rules may require trusted users to access the network with USB tokens, fingerprint scanners, or similar layers of protection. In this case, if the system does not detect a token, then the system may block access through the client (and possibly through the server) based on the applicable rules.

Rules may also be used to set both local and remote CVE scans. For example, Open Vulnerability and Assessment Language (OVAL) scans (that is, local CVE inspections) can be set to take place at certain times and/or dates. Remote scans can be set to run by the server with information stored on the server's calendar and scheduling engine. See http://oval.mitre.org or the NetClarity FREESCAN tool for more information on client (local) scans and server (remote) scans.

Other rules may tie blocking network access to time schedules and/or trusted asset list. For instance, if a system tries to access the network during off hours, then access may be blocked using agentless Denial-of-Service (DoS) ‘attack’ methodology. DoS methodologies involve remotely reconfiguring the client's ARP table, a process known as ARP table twittling, diddling, or poisoning. One example of such a process is a NetClarity EasyNAC block event.

In addition, clients may generate and ship alert, result, log, and report data to the server when necessary so the server can report what has occurred within and without policy on an end-user client computer. Adding time and location information to the data improves the ability to manage the system. For example, consider a student who is allowed to browse any website or run any service from the dorms, but is not allowed unlimited access on school network, including wireless networks in labs or classrooms. This prevents the student from hogging bandwidth by running file-sharing applications, such as Napster, or high-risk applications, such as Remote Helpdesk, Instant Messenger, or SKYPE.

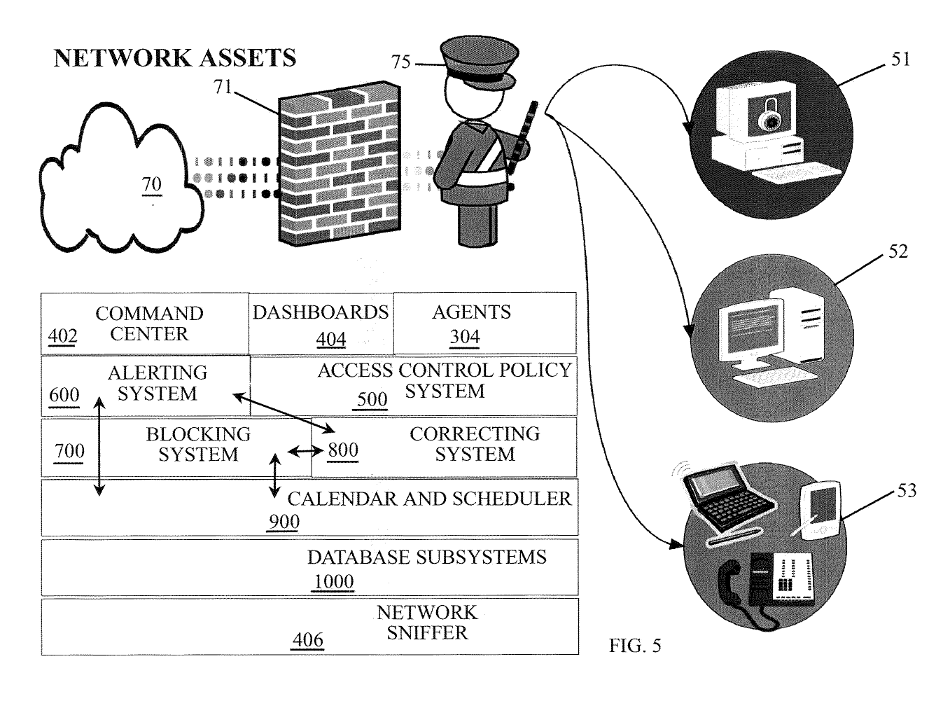

FIG. 5 is a schematic view of the architecture of one embodiment of the present invention. The embodiment includes a command center 402 that allows a user, such as an administrator, to control the system using dashboards 404 or other interfaces. The dashboards 404 also allow the user to set and administer policies of a NAC policy system 500 relating to (optional) agents 304. For example, the user can set allowed access time and/or locations using a calendar and scheduler 900. The calendar and scheduler 900 is coupled to an alerting system 600, a blocking system 700, and a correcting system 800, all described in greater detail below. The alerting, blocking, and correcting systems 600, 700, and 800 are coupled, in turn, to a database subsystems 1000 that log, store, and retrieve information relating to NAC policies and access attempts. In preferred embodiments, the alerting system 600 may be coupled to a network sniffer 406 that detects information about hosts including, but not limited to: media access controller (MAC) address, ARP, DHCP, internet protocol (IP) address, TCP, UDP, host name, and operating system (OS).

Example layers can alert, block, and correct many types of unauthorized network use, including, but not limited to: unauthorized Peer-to-Peer access; unauthorized LAN or WAN access; and unauthorized Internet and demilitarized zone (DMZ) access. Layers related to the credentials of the users include but are not limited to computer or network device identifiers, such as central processing unit (CPU) identification, operating system, hostname, IP address, and MAC address. Other layers may examine identifiers such as end-user identifiers (e.g., Userid, Password, Soft-token, Physical USB or other Token), policies around the health of the device, and access rules for the user including, but not limited to dates, times, resources and other limitations.

### Alerting System

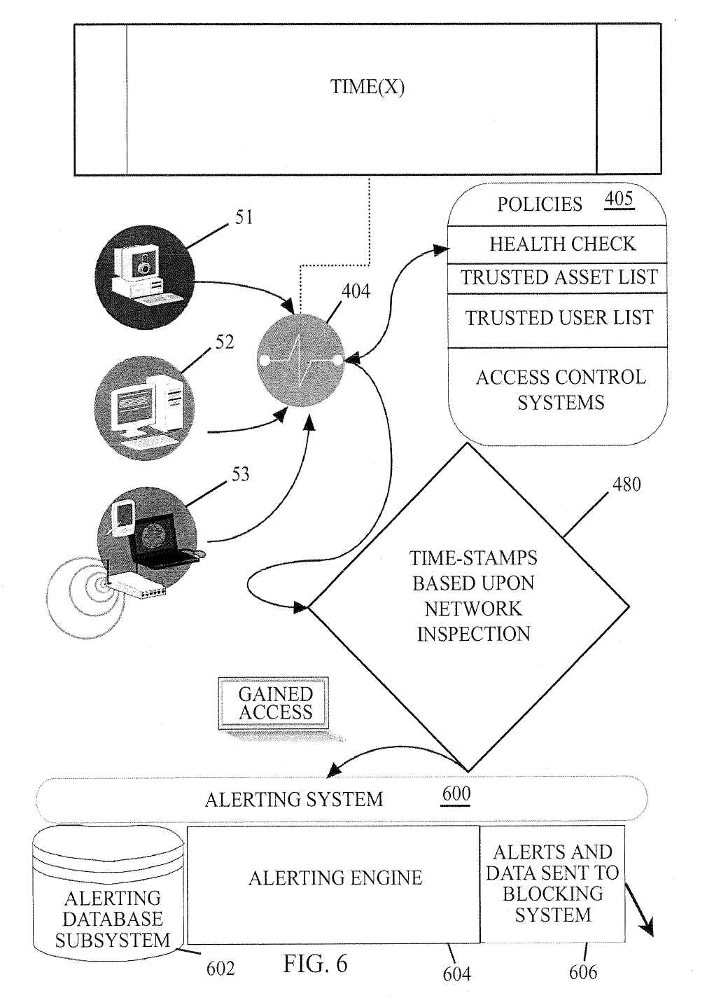

FIG. 6 is an illustration that shows how an alerting system 600 is used during assessment, application, and enforcement of NAC policies 405 according to embodiments of the present inventive system and method. As in FIG. 4, an access point 404 receives access requests from trusted, healthy hosts 51, trusted, weak, and infected hosts 52, and untrusted, malicious, and rogue hosts 53. The access point 404 then applies policies 405 to determine whether or not to grant access requests from the hosts 51-53. As stated above, assessment may include checks of: remote and local health; trusted asset lists; trusted user lists; and access control systems.

Based upon the inspection/assessment of the network asset (i.e., hosts 51-53) and/or user, a time engine 480 creates multiple user time-stamps and alerting/log information. The time-stamps and alerting/log information are passed to the alerting system 600, which logs and stores the time-stamps and alerting/log information in an alerting database subsystem 602. The time-stamps and alerting/log information can be retrieved later for later analysis, reporting, or transfer.

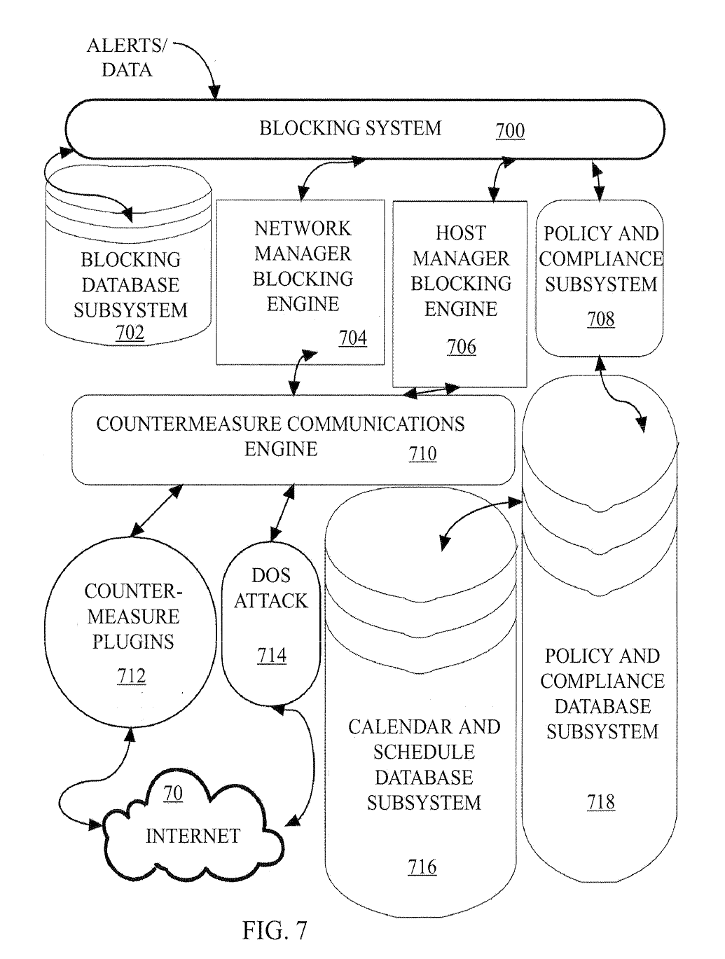

If the hosts 51-53 attempting to access the network are untrusted or unhealthy, the alerting system 600 issues an alert 606 that may include information about the host, user, and attempt to gain access to the network. In preferred embodiments, the alerting system 600 uses an alerting engine 604 to send the alerts 606 along with any relevant data to a blocking system 700 (shown in FIG. 7). The alerting engine 604 may interface with the blocking system 700 using any of a wide range of methodologies and protocols, including, but not limited to: short-message service (SMS); simple network management protocol (SNMP); simple mail transfer protocol (SMTP); Syslog; e-mail; hypertext transfer protocol (HTTP); secure hypertext transfer protocol (HTTPS); secure sockets layer (SSL); transport layer security (TLS); file transfer protocol (FTP); and Samba. In addition, extensible application programming interfaces (APIs) and software development kits (SDKs) can be used to create new alert interfaces, possibly using extensible markup language (XML) or really simple syndication (RSS).

### Blocking System

FIG. 7 is an illustration that shows how a blocking system 700 is used to block attempts to access the network by untrusted or unhealthy hosts according to embodiments of the present inventive system and method. The blocking system 700 receives alerts and data from the alerting system 600 (FIG. 6) and distributes the data to a blocking database subsystem 702, a network manager blocking engine 704, a host manager blocking engine 706, and a policy and compliance subsystem 708. The blocking database subsystem logs, stores, and retrieves data, including data generated by the other engines and subsystems.

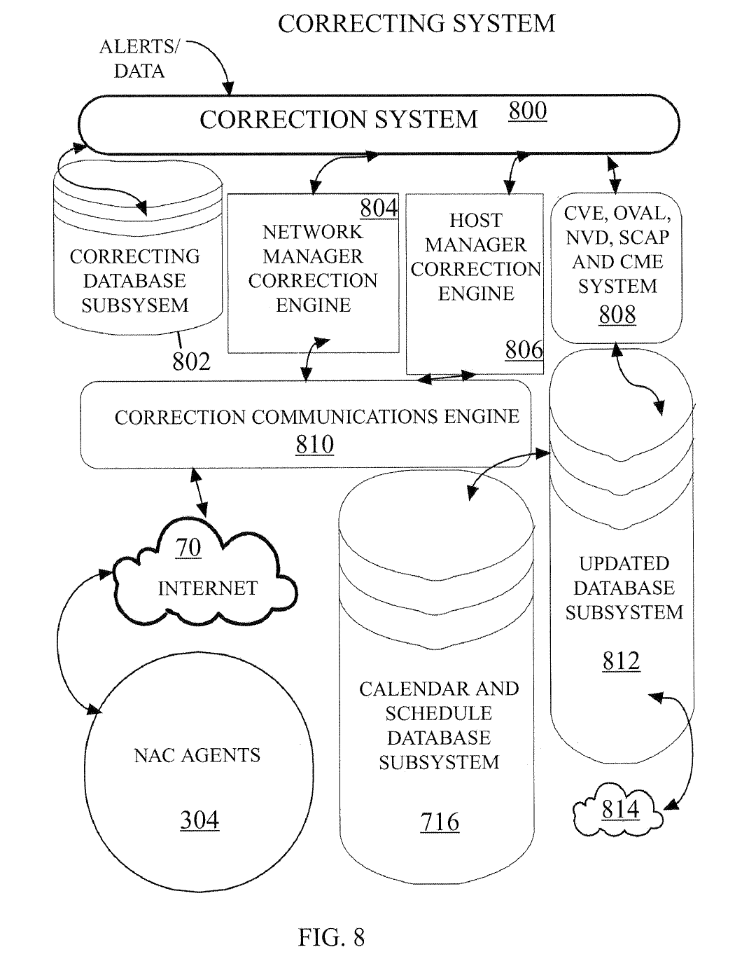

The blocking system 700 communicates with the policy and compliance subsystem 708 to determine how the access attempt should be blocked. For example, access attempts from a trusted but noncompliant host 52 might be allowed after the host is brought into compliance by a correction system 800 (shown in FIG. 8). Access attempts from untrusted or malicious hosts 53 might never be allowed. The policy and compliance subsystem 708 also communicates with a policy and compliance database subsystem 718 that includes policy information and group management information at the most granular level necessary to apply and enforce the policy. This information may be stored in tables for adding, deleting, and renaming groups and group policy information. Example tables may include lists of allowed resources, such as applications, processes, ports, devices, and protocols.

The policy and compliance database subsystem 718 is also coupled to a calendar and schedule database subsystem 716 that maintains granular information about when particular users can access particular network assets. This particular schedule can be set for any granularity ranging from, for example, granularity by the second to granularity by the year. For example, consider a corporation that has conference rooms with live wireless ports that can be used for meetings. If wireless ports on the network were only available from 7 am to 6 pm every day, then they could be scheduled to be automatically blocked from 6 pm until 7 am every day. That way, if someone malicious were to attempt to access the network via the wireless ports at 7:30 pm, the blocking system 700 would block the malicious access attempt immediately. All of this information would be logged and stored in the various database subsystems, including the blocking database subsystem 702, for later retrieval and use.

The network manager blocking engine 704 and the host manager blocking engine 706 block access to resources based on the applied policy. The host manager blocking engine 706 blocks access to local (host-based) resources by communicating with agent or client software (e.g., optional NAC agent 304 shown in FIG. 3).

Both engines 704 and 706 interact with a countermeasure communications engine 710 to enforce NAC policies supplied by the policy and compliance subsystem 708. The countermeasure communications engine 710 communicates, in turn, with countermeasure plugins 712 and a denial-of-service (DoS) attack engine 714, each of which are coupled to a network 70, such as the Internet. Example plugins 712 include plugins relating to proxy servers, firewalls 71 (FIG. 3), IDSs, IPSs, smart switches, antivirus software, VPNs, NAC clients, tokens, and biometric user identification.

Embodiments of the present invention have multiple methodologies to block a network asset from gaining access to the public or private network whether the asset be trusted, trusted but weak, infected or out of compliance with one or more policies or is rogue, un-trusted and/or malicious. These blocking methodologies include but are not limited to: dynamic reconfiguration of firewall rules tables; communication through APIs or command line interfaces with intelligent or smart switches; creation, editing and updating of VLANs, access control lists (ACLs) and proxy servers; VPNs; software clients or agents; servers and services; network protocol stacks; and operating systems.

### Correction System

FIG. 8 is an illustration that shows how a correction system 800 is used to correct problems related to attempts to access the network by untrusted or unhealthy hosts according to embodiments of the present inventive system and method. The correction system 800 receives blocking and correction data from the blocking system 700 (FIG. 7) and determines necessary correction action using the received data. In the embodiment shown in FIG. 8, the correction system 800 communicates with a correction database subsystem 802, a network manager correction engine 804, a host manager correction engine 806, and a common vulnerabilities and exposures (CVE) system 808 to perform the necessary correction.

The correction system 800 communicates with the CVE subsystem 808 to determine how to perform the necessary correction. The CVE subsystem 808, in turn, retrieves information from a dynamically updated CVE database subsystem 812 that maintains information relating to CVEs, OVAL, National Vulnerability Database (NVD), Security Content Automation Protocol (SCAP), and Cisco Unified Communications Manager Express (CUCME; also known as Cisco Unified CallManager Express and Cisco CallManager Express). The CVE database subsystem 812 receives real-time RSS feeds to refresh information relating to the latest threats and best practices related to applications, processes, ports, protocols, and devices. Preferred embodiments of the CVE database subsystem 812 are coupled to a secure update system 814, such as the MITRE Corporation CVE database, using secure RSS. The CVE database subsystem 812 may also be coupled to the calendar and schedule database 716 described above with reference to FIG. 7.

The CVE subsystem 808 supplies the latest correction/remediation information stored in the CVE database subsystem 812 to the correction system 800, which uses the supplied information to determine how to correct the detected network problem. To correct network problems, the network manager correction engine 804 communicates the problems to a correction communications engine 810, which dynamically resolves the problems to create a healthier network environment and enforce NAC policies. The correction communications engine 810 is coupled to a network 70, such as the Internet, which is coupled, in turn, to optional NAC agents 304 that enforce policies to improve the posture of trusted hosts, clients, and systems according to NAC policies. Example correction policies include, but are not limited to: removing CVEs and malware; updating systems; and integrating with Microsoft® Windows® Server Update Services (WSUS).

The host manager correction engine 806 (possibly along with correction communications engine 810) resolves local (host-based) problems by communicating securely with agent or client software (e.g., optional NAC agent 304 shown in FIG. 3). The problem is then resolved according to the appropriate NAC policy.

Embodiments of the present invention have multiple ways to provide correction of unhealthy network conditions such as automated patching, system reconfiguration, starting and stopping services, applications and opening or closing various network ports on network assets or by providing instructions to a trusted user of the system on specific problems and how to correct them which may also include but is not limited to the removal of CVEs.

### Detection, Discovery, Defense, and Defeat Systems

Embodiments of the present invention utilize multiple methodologies on public and private networks, whether wired or wireless or a combination of both to detect trusted and un-trusted network assets including but not limited to ping sweeps, passive traffic and asset discovery, signature and heuristic methodologies to detect a network asset fingerprint which includes but is not limited to MAC address, IP address, hostname, operating system and other relevant information which can be used to differentiate and prove the uniqueness of one network asset from another.

Embodiments of the present invention utilize multiple methodologies on public and private networks, whether wired or wireless or a combination of both to discover all common vulnerabilities and exposures (CVEs), applications, processes and ports running on trusted and un-trusted network assets as well as policy violations and any other information which can be discovered using a clientless approach, a client-based approach, whereby a software agent is installed on the network asset and a combination of both clientless and client-based to provide information to the.

Embodiments of the present invention utilize multiple methodologies on public and private networks, whether wired or wireless or a combination of both to defend against internal peer to peer attacks, the propagation of malware such as trojans, keyloggers, worms, viruses, spyware, adware and other malicious code from spreading and infecting other network assets and to defend against a malicious insider from gaining access to any network asset and to defend against a malicious insider from enabling a rogue wireless router or other wireless device to allow for data mangling, data theft and/or data leakage and to block against data leakage through infrared, wireless, wired, Bluetooth, PDA, USB, floppy, CD-R, CD-RW, DVD-R and DVD-RW devices.

Embodiments of the present invention utilize multiple methodologies on public and private networks, whether wired or wireless or a combination of both to defeat malware, hackers, rogue devices and malicious insiders by killing their network access to the private network, peer systems and/or a public Internet in real-time and as needed through a time-based approach with calendar and scheduling and by knowing which network assets are trusted, which are trusted but weak, infected or out of compliance with one or more policies and which are un-trusted.

### Time System

Embodiments of the present invention keep track of time at the highest rate (precision) possible and use a time system 480 (FIG. 6) to determine how long a trusted or untrusted asset has been on the public and/or private network. The time-based data is used by the alerting engine 604 (FIG. 6) to create time-stamps that are used by the blocking system (700) to track the moment of entry, exit and the actual block event. In turn, the correction system 800 (FIG. 8) time-stamps when a problem was discovered and when it was corrected. For calendar and scheduling purposes, the invention system creates a time-based network admission control system, whereby trusted assets may be taken off the private and/or public network on a calendar and scheduled basis. This time scheduling not only controls network access but also may control energy use levels by scheduling when an asset is to be in a power saving mode (e.g., hibernate, standby, other similar modes of operation) as further disclosed below.

### Policy and Compliance Definitions

Policy engines can be used to create and manage NAC policies. Defining rules that are flexible enough not to unduly burden end users yet strict enough to protect the network takes planning and testing. A binary policy, such as, “Comply with the current policy or be denied access,” sounds good on paper, but often fails in the real world. For instance, a laptop that has been offline, possibly because the associated user was on vacation, may not be up-to-date on its antivirus signature, but that does not mean that it is infected. Preferably, policy engines include or are linked to user interfaces or dashboards that allow administrators to build custom objects and easily readable rule sets.

Embodiments of the present invention are accessible by one or more trusted users of this system to control, configure and manage the multi-layered time-based network access control system and may be accessible through a web-browser or a software client which is authenticated to use the system API.

Embodiments of the present invention have structured function calls and variable definitions for trusted, secure, local and/or remote access to most or all of the functionality of the system.

Embodiments of the present invention have structured command line interfaces with variable definitions and settings for trusted, secure, local and/or remote access to most or all of the functionality of the system.

Embodiments of the present invention deliver various methodologies including but not limited to public/private key, encryption and other means such as SSH or SSL/TLS to ensure that GUI, API and CLI access are confidential, authenticated and secure.

Embodiments of the present invention store all information necessary for the system to function properly and for tracking of all information deemed useful to make the system function properly and for reporting, logging and forensic purposes.

Embodiments of the present invention provide predefined policy templates and user-defined policies which may be used to drive network admission control decisions such as alerting, blocking and correcting of trusted or un-trusted network asset access including but not limited to setting thresholds and measures around state of health of a network asset, what applications, services, protocols and ports a network asset may utilize and when they may utilize these resources whether in real-time or on a scheduled basis for self-determined best practices.

Embodiments of the present invention provide predefined compliance templates and user-defined templates including but not limited to GLBA, HIPAA, Sarbanes-Oxley (SOX), ISO17799, ISO27001, VISA PCI and other country-based regulations which are examined automatically to determine the risk of causing an out-of-compliance status of access to a public or private network by a network asset and to help drive network admission control decisions such as alerting, blocking and correcting of trusted or un-trusted network asset access including but not limited to setting thresholds and measures around state of health of a network asset, what applications, services, protocols and ports a network asset may utilize and when they may utilize these resources whether in real-time or on a scheduled basis for government-based, organizational-based or self-determined guidelines for compliance.

Embodiments of the present invention are driven by the GUI, API and/or CLI to create schedules of network admission control (NAC) events and uses the Time engine to track and ensure these schedules are running on time and to help the Alerting, Blocking and Correction Systems 600, 700, 800 function in a way that is useful for the end-user of this system. For example, when employees leave a bank at 5 pm and return to the office at 8 am, the system can be configured for one network asset or a group of network assets, such as the teller machines, to NOT be allowed public and/or private network access during off hours, i.e., from 5 pm until 8 am, which would in turn invoke the Blocking System 700 against these network assets, for this period of time, even though they are trusted.

The invention is able to generate reports based on templates and dynamically in an array of formats including but not limited to PDF, Text, CSV, HTML, XML and SQL output.

Energy Savings with Power Management Tools (Endpoint Defender and EnergyStar)

Further embodiments of the present inventive system include a power management tool to enable a sleep mode for computers and monitors, possibly as scheduled and managed by an information technology (IT) administration. Power management tools enable computers and monitors to go into a low-power sleep mode after a period of inactivity and have the potential to save up to $50 per computer annually. Despite the significant savings, according to Lawrence Berkeley National Labs, only a scant five to ten percent of U.S. organizations have deployed these settings on computers.

The power management tool helps reduce global growing demand for electricity, saves money, and helps fight global warming. For perspective, if all office computers and monitors in the United States were set to sleep when not being used, the country could save more than 44 billion kilowatt-hours or $4 billion worth of electricity and eliminate greenhouse gas emissions equivalent to those of about 5 million cars each year.

Embodiments of the power management tool also include IT security functionality including disabling USB ports, shutting off high risk services, enforcing patch management, and scanning for the latest virus. For example, certain embodiments include built-in antivirus software, such as the ClamWin virus scanner. Embodiments can also shut down firewalls during scheduled audits and assessments. They can also turn off high-risk services, such as Remote Help Desk, which allows remote control of the computer. Further embodiments can force Enable Patch management with local patch servers or hosted servers. The power management tool can also find and fix operating system (e.g., Microsoft® Windows®) vulnerabilities using OVAL integration.

The disclosed inventive system can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A security apparatus for a computer-based network, the apparatus comprising:
an alerting system determining a current state of the computer-based network including any of an introduction, re-introduction, removal, or off-line condition of a network asset of the computer-based network;
a blocking system, in communication with the alerting system, preventing the network asset from gaining access to the computer-based network; and
a time engine providing time information to at least one of the alerting and blocking systems.

2. The security apparatus as claimed in claim 1 wherein the alerting system determines the current state of the computer-based network by checking network assets at multiple layers, the layers including, but not limited to, at least one of: health checks, such as common vulnerabilities and exposures (CVEs), anti-virus status, anti-malware status, patches installed; identity and policy enforcement agents; universal serial bus tokens; fingerprint scanners; and core signatures, the core signatures including, but not limited to: operating systems; network ports; applications; services; memory; internet protocol addresses; media access controller addresses; open or closed data ports such as infrared, wireless, keyboard, mouse, USB, and Bluetooth ports; and time.

3. The security apparatus as claimed in claim 1 wherein the alerting system comprises:
an alerting engine applying network access control policies to network assets, checking health of network assets, and maintaining trusted user lists and access control systems.

4. The security apparatus as claimed in claim 1 wherein the alerting system creates time schedules based on information from the time engine.

5. The security apparatus as claimed in claim 4 wherein the blocking system uses time schedules of each network asset to determine when to block a network asset from the computer-based network.

6. The security apparatus as claimed in claim 1 wherein the blocking engine prevents network assets from gaining access to the computer-based network at plural layers, the layers including, but not limited to, at least one of: a denial-of-service stream; a smart switch; a physical Ethernet port; network ports and a firewall.

7. The security apparatus as claimed in claim 1 wherein the blocking engine dynamically reconfigures access to the computer-based network to block malware, hackers, rogue devices, and malicious insiders by terminating all or part of their network access.

8. The security apparatus as claimed in claim 1 wherein the blocking system includes:
a network manager blocking engine that controls access to network assets based on network access control policies.

9. The security apparatus as claimed in claim 8 wherein the blocking system includes:
a host manager blocking engine blocking access to local assets by communicating securely with agent or client software based on network access control policies;
a countermeasures communications engine dynamically reconfiguring countermeasures to enforce network access control policies; and
a policy and compliance subsystem maintaining tables for changing group policy information of the network access control policies.

10. The security apparatus as claimed in claim 1 wherein the time engine is used to create, enable, and track schedules of network access control.

11. The security apparatus as claimed in claim 10 wherein the schedules are set so that the security apparatus only grants access to network assets based on at least one of: specified time intervals; current time; device identification; and user identification.

12. The security apparatus as claimed in claim 1 further including:
a correction system in communication with at least one of the alerting system, the blocking system, and the time engine, the correction system providing correction of the network problem.

13. The security apparatus as claimed in claim 12 wherein the correction system records time stamps associated with when the network problem was discovered and when the network problem was corrected.

14. The security apparatus as claimed in claim 12 wherein the correction system includes at least one of:
a network manager correction engine correcting information related to network assets based on network access control policies;
a host manager correction engine correcting local issues by communicating securely with agent or client software based on network access control policies;
a correction communications engine dynamically resolving network problems to create a healthier network environment and to enforce network access control policies; and
a vulnerabilities subsystem maintaining information relating to vulnerabilities of network assets.

15. The security apparatus as claimed in claim 1 further comprising:
an interface enabling a user to apply policy templates and policies relating to network access control decisions including alerting determinations and blocking access to selected network assets.

16. The security apparatus as claimed in claim 15 wherein enabling a user to apply templates and policies includes allowing the user to set thresholds and measures around a state of health of a network asset.

17. The security apparatus as claimed in claim 15 wherein the policy templates include compliance templates, pre-defined templates, and user-defined templates.

18. The security apparatus as claimed in claim 1 further including:
a network sniffer scanning connection interfaces of network assets to the computer-based network.

19. The security apparatus as claimed in claim 1 further including:
an energy conservation interface placing a network asset in a power down, standby, or hibernate mode to reduce emissions.

20. A computer method of controlling access to a computer-based network, the method comprising:
receiving an indication of an attempt to gain access to a computer-based network;
at each of multiple security layers, applying a respective network access control policy to determine whether to allow the attempt to gain access to the computer-based network; and
based on the application of the respective network access control policy at each security layer, allowing or blocking the attempt to gain access through the security layer to the computer-based network.

21. The computer method as claimed in claim 20 wherein applying the respective network access control policy includes at least one of: determining whether the attempt to gain access is occurring during an allowed access time; determining whether the attempt to gain access is occurring from an allowed physical location or on an allowed network asset; authenticating a token associated with a particular user or a particular network asset; and determining whether the attempt to gain access is directed towards a selected network asset.

22. The computer method as claimed in claim 20 further including:
recording when the attempt to gain access to the computer-based network occurs; and
logging the attempt to gain access to the computer-based network.
